(19) United States
(12) Patent Application Publication
(10) Pub. No.: US 2024/0037394 A1
(43) Pub. Date: Feb. 1, 2024

(54) SYSTEM AND METHOD FOR NEURAL NETWORK MULTIPLE TASK ADAPTATION

(71) Applicants: Deliang Fan, Tempe, AZ (US); Fan Zhang, Tempe, AZ (US); Li Yang, Tempe, AZ (US)

(72) Inventors: Deliang Fan, Tempe, AZ (US); Fan Zhang, Tempe, AZ (US); Li Yang, Tempe, AZ (US)

(73) Assignee: Arizona Board of Regents on behalf of Arizona State University, Scottsdale, AZ (US)

(21) Appl. No.: 18/360,140

(22) Filed: Jul. 27, 2023

Related U.S. Application Data
(60) Provisional application No. 63/369,578, filed on Jul. 27, 2022.

(51) Int. Cl. G06N 3/08; G06N 3/04; G06N 3/063

(52) U.S. Cl. CPC G06N 3/08; G06N 3/04; G06N 3/063

(57) ABSTRACT

A neural network accelerator architecture for multiple task adaptation comprises a volatile memory comprising a plurality of subarrays, each subarray comprising M rows and N columns of volatile memory cells; a source line driver connected to a plurality of N source lines, each source line corresponding to a column in the subarray; a binary mask buffer memory having size at least N bits, each bit corresponding to a column in the subarray, where a 0 corresponds to turning off the column for a convolution operation and a 1 corresponds to turning on the column for the convolution operation; and a controller configured to selectively drive each of the N source lines with a corresponding value from the mask buffer; wherein each column in the subarray is configured to store a convolution kernel.

### CROSS-REFERENCE TO RELATED APPLICATIONS

This application claims priority to U.S. Provisional Patent Application No. 63/369,578, filed on Jul. 27, 2022, incorporated herein by reference in its entirety.

### STATEMENT REGARDING FEDERALLY SPONSORED RESEARCH OR DEVELOPMENT

This invention was made with government support under 1931871 and 2003749 awarded by the National Science Foundation. The government has certain rights in the invention.

### BACKGROUND OF THE INVENTION

Nowadays, one practical limitation of deep neural networks (DNNs) are their high degree of specialization to a single task. This motivates researchers to develop algorithms that can adapt the DNN model to multiple tasks sequentially, while still performing well on past tasks. This process of gradually adapting the DNN model to learn from different tasks over time is known as multitask adaptation. Fine-tuning is a natural way to adapt the current model (i.e., backbone model) to a new task. However, updating the parameters of the backbone model could result in forgetting old knowledge upon earlier tasks, thus degrading performance. This phenomenon is known as catastrophic forgetting, which widely exists in multi-task adaptation. To alleviate catastrophic forgetting, several mask-based methods have been proposed i.e., Piggyback and KSM (A. Mallya et al., Proceedings of the European Conference on Computer Vision (ECCV), 2018, pp. 67-82; L. Yang et al., Proceedings of the IEEE/CVF Conference on Computer Vision and Pattern Recognition, 2021, pp. 13 845-13 853), which only learn a task specific mask with respect to all weights for each new task, while keeping the backbone model fixed.

From the DNN hardware accelerator design domain, DNN involves a huge amount of multiply-and-accumulate (MAC) operations and data movement. In a traditional von Neumann architecture (e.g., CPU, GPU), data movement consumes ˜100×higher energy than a floating-point operation which is also known as “memory wall” (S. Mittal, Machine Learning and Knowledge Extraction, vol. 1, no. 1, pp. 75-114, 2019). Recently, in-memory computing (IMC) has attracted an increasing interest due to its ability to execute computing tasks directly within the memory array. This significantly alleviates the “memory wall” issue (L. Song et al., 2017 IEEE International Symposium on High Performance Computer Architecture (HPCA), 2017, pp. 541-552; X. Sun et al., 2018 Design, Automation Test in Europe Conference Exhibition, 2018, pp. 1423-1428; C. Eckert et al., Proceedings of the 45th Annual International Symposium on Computer Architecture, ser. ISCA '18. IEEE Press, 2018, p. 383-396; D. Fan et al., 2017 IEEE International Conference on Computer Design (ICCD), 2017, pp. 609-612). Among different volatile/non-volatile IMC designs, a resistive random-access memory (ReRAM) crossbar-based design is a promising candidate for a next-generation DNN accelerator, due to its simple structure, high on/off ratio, high density, multibit per cell storage, and fabrication compatibility with CMOS (S. Mittal, Machine Learning and Knowledge Extraction, vol. 1, no. 1, pp. 75-114, 2019; L. Song et al., 2017 IEEE International Symposium on High Performance Computer Architecture (HPCA), 2017, pp. 541-552; X. Sun et al., 2018 Design, Automation Test in Europe Conference Exhibition, 2018, pp. 1423-1428; M. Hu et al., 2016 53nd ACM/EDAC/IEEE Design Automation Conference (DAC), 2016, pp. 1-6).

Thus, there is a need in the art for a method and device for accelerating DNN inference with multiple task adaptation in order to reduce mask memory size and reduce energy consumption.

### SUMMARY OF THE INVENTION

In one aspect, the device contemplated herein comprises a neural network accelerator architecture for multiple task adaptation, comprising: a volatile memory comprising a plurality of subarrays, each subarray comprising M rows and N columns of volatile memory cells; a source line driver connected to a plurality of N source lines, each source line corresponding to a column in the subarray; a binary mask buffer memory having size at least N bits, each bit corresponding to a column in the subarray, where a 0 corresponds to turning off the column for a convolution operation and a 1 corresponds to turning on the column for the convolution operation; and a controller configured to selectively drive each of the N source lines with a corresponding value from the mask buffer; wherein each column in the subarray is configured to store a convolution kernel.

In some embodiments, the volatile memory is random access memory.

In some embodiments, the volatile memory is a resistive random access memory.

In some embodiments, the device further comprises a real-valued mask buffer configured to store a calculated real-valued mask; and a sigmoid element configured to convert the real-valued mask into a binary mask for storage in the binary mask buffer memory.

In some embodiments, the real-valued mask buffer comprises floating-point values and the sigmoid element is a thresholding element having a threshold of 0.5.

In some embodiments, each volatile memory cell stores 2 bits.

In some embodiments, the device further comprises a plurality of N/2 shift-adders, each configured to combine two 2-bit weights from adjacent columns of the subarray into a 4-bit partial sum activation.

In some embodiments, the binary mask buffer memory has a size of at least 2N bits, and is configured to store two separate masks of size N, each bit of each mask corresponding to a column in the subarray.

In one aspect, the method for neural network acceleration contemplated herein comprises loading a backbone model into a volatile memory, the volatile memory comprising a plurality of subarrays, each subarray comprising M rows and N columns of volatile memory cells, wherein each column of the N columns is configured to store a convolution kernel of the backbone model; selecting a set of tasks to run on the backbone model, each task having a corresponding binary mask configured to enable or disable each of the N columns of the subarray; selecting one task of the set of tasks and applying the binary mask corresponding to the task to the N columns of the subarray, disabling at least one column of the subarray; an executing the task on the backbone model, ignoring the disabled convolution kernel to calculate a result.

In some embodiments, the method further comprises the steps of calculating real-valued masks to correspond to each task in the set of tasks; and calculating the corresponding binary masks from the real-valued masks with a sigmoid function.

In some embodiments, the method further comprises wherein the volatile memory is random-access memory.

In some embodiments, the method further comprises wherein the random-access memory is a resistive random-access memory.

In some embodiments, the method further comprises calculating a first partial sum in a first subarray of the plurality of subarrays, and a second partial sum in a second subarray of the plurality of subarrays; and combining the first and second partial sums to calculate an activation.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 is a diagram of a computing device.

FIG. 2 is a diagram of different retraining strategies.

FIG. 3 is a diagram showing a ReRAM one-transistor-one-resistor (1T1R) crossbar array.

FIG. 4 is diagram depicting the overall working flow of a proposed Crossbar Binary Mask (XBM).

FIG. 5 is a diagram depicting the binary mask training using a combination of Gumbel-Sigmoid function and hard thresholding according to an aspect of the present invention.

FIG. 6 depicts a ReRAM Crossbar based Neural Network (NN) accelerator architecture and weight mapping according to an aspect of the present invention.

FIG. 7 is an exemplary method for neural network acceleration according to aspects of the present invention.

FIG. 8 shows experimental results of a binary mask sparsity comparison of Piggyback vs. XBM for the various image classification datasets.

FIG. 9 shows the experimental results for an area breakdown of 4-bit ResNet-50 backbone model hardware deployment including an RRAM Array, Global Buffer and Adder+Rectified Linear Unit (ReLU)+Mask Buffer.

FIG. 10 is a graphical representation of energy consumption per image for various methods and datasets.

FIG. 11 shows the experimental results for energy consumption (reprogramming energy & inference energy per dataset) of the reprogramming of various image classification datasets using the learning methods of Finetune, Piggyback and XBM.

### DETAILED DESCRIPTION

It is to be understood that the figures and descriptions of the present invention have been simplified to illustrate elements that are relevant for a clear understanding of the present invention, while eliminating, for the purpose of clarity, many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

### Software & Computing Device

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C #, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

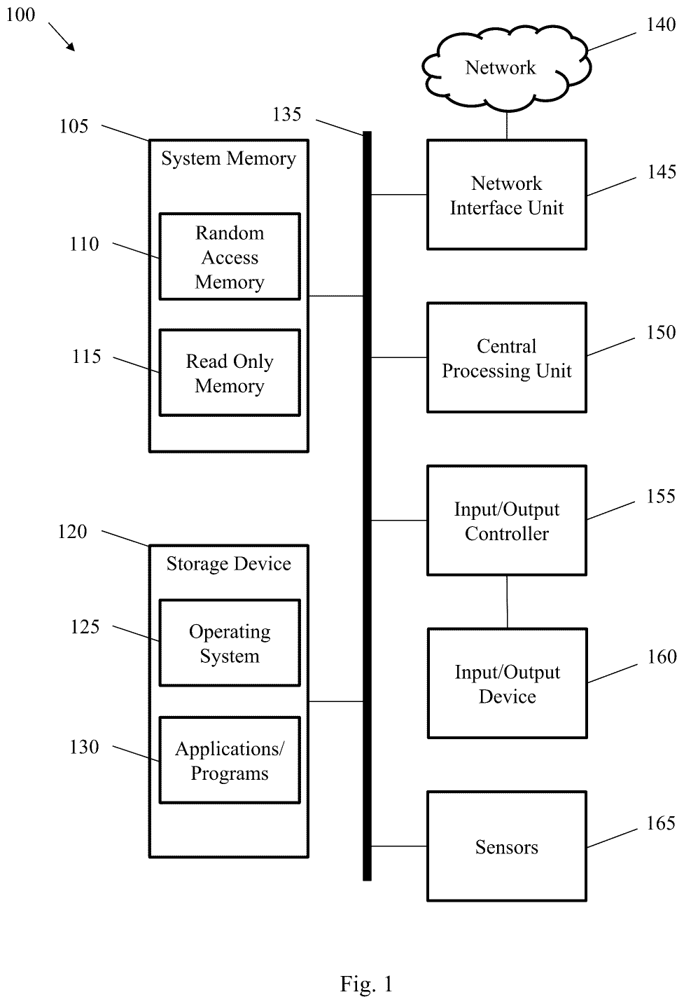

FIG. 1 and the following discussion are intended to provide a brief, general description of a suitable computing environment in which the invention may be implemented. While the invention is described above in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 1 depicts an illustrative computer architecture for a computer 100 for practicing the various embodiments of the invention. The computer architecture shown in FIG. 1 illustrates a conventional personal computer, including a central processing unit 150 (“CPU”), a system memory 105, including a random access memory 110 (“RAM”) and a read-only memory (“ROM”) 115, and a system bus 135 that couples the system memory 105 to the CPU 150. A basic input/output system containing the basic routines that help to transfer information between elements within the computer, such as during startup, is stored in the ROM 115. The computer 100 further includes a storage device 120 for storing an operating system 125, application/program 130, and data.

The storage device 120 is connected to the CPU 150 through a storage controller (not shown) connected to the bus 135. The storage device 120 and its associated computer-readable media provide non-volatile storage for the computer 100. Although the description of computer-readable media contained herein refers to a storage device, such as a hard disk or CD-ROM drive, it should be appreciated by those skilled in the art that computer-readable media can be any available media that can be accessed by the computer 100.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 100 may operate in a networked environment using logical connections to remote computers through a network 140, such as TCP/IP network such as the Internet or an intranet. The computer 100 may connect to the network 140 through a network interface unit 145 connected to the bus 135. It should be appreciated that the network interface unit 145 may also be utilized to connect to other types of networks and remote computer systems.

The computer 100 may also include an input/output controller 155 for receiving and processing input from a number of input/output devices 160, including a keyboard, a mouse, a touchscreen, a camera, a microphone, a controller, a joystick, or other type of input device. Similarly, the input/output controller 155 may provide output to a display screen, a printer, a speaker, or other type of output device. The computer 100 can connect to the input/output device 160 via a wired connection including, but not limited to, fiber optic, Ethernet, or copper wire or wireless means including, but not limited to, Wi-Fi, Bluetooth, Near-Field Communication (NFC), infrared, or other suitable wired or wireless connections.

As mentioned briefly above, a number of program modules and data files may be stored in the storage device 120 and/or RAM 110 of the computer 100, including an operating system 125 suitable for controlling the operation of a networked computer. The storage device 120 and RAM 110 may also store one or more applications/programs 130. In particular, the storage device 120 and RAM 110 may store an application/program 130 for providing a variety of functionalities to a user. For instance, the application/program 130 may comprise many types of programs such as a word processing application, a spreadsheet application, a desktop publishing application, a database application, a gaming application, internet browsing application, electronic mail application, messaging application, and the like. According to an embodiment of the present invention, the application/program 130 comprises a multiple functionality software application for providing word processing functionality, slide presentation functionality, spreadsheet functionality, database functionality and the like.

The computer 100 in some embodiments can include a variety of sensors 165 for monitoring the environment surrounding and the environment internal to the computer 100. These sensors 165 can include a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

### Crossbar Binary Mask (XBM)

Almost all existing related works utilize a ReRAM crossbar as an area and energy efficient hardware for deployment of DNN inference on a single specialized task or domain, but there is little consideration to support multiple task adaptation based on a ReRAM crossbar. In this context, to adapt a current model deployed in ReRAM crossbar for a new task, the most intuitive and straight-forward way is to fine-tune the weight parameters (i.e., cell conductance) based on any new knowledge. However, this scheme requires updating the conductance of almost all cells to reflect the new set of fine-tuned weight parameters, which is inefficient and impractical in real-world multi-task learning due to the limitations of both the ReRAM device (e.g., high re-programming power, limited endurance, etc.) and algorithm (e.g., catastrophic forgetting for large scale multi-task learning). As discussed earlier, mask-based multi-task learning is currently one of the most popular methodologies to address the catastrophic forgetting issue.

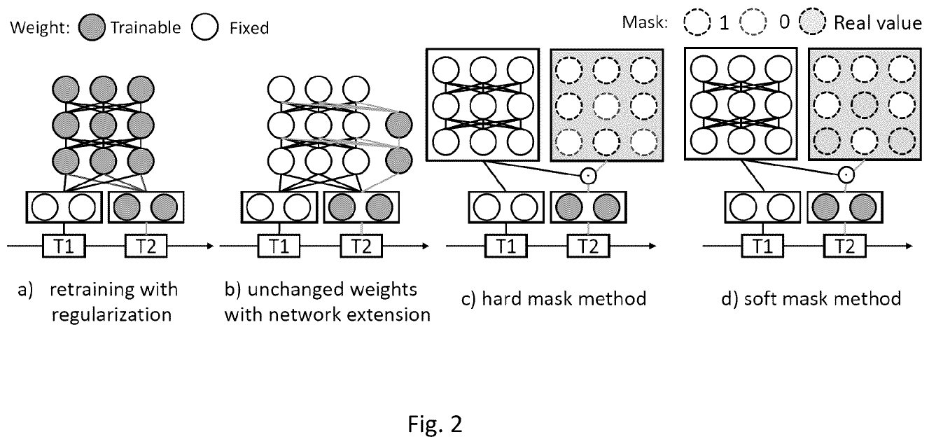

To apply the representative Piggyback (A. Mallya et al., Proceedings of the European Conference on Computer Vision (ECCV), 2018, pp. 67-82) mask learning method to ReRAM crossbar hardware requires learning a binary element-wise mask ({0, 1}) with respect to all the weights for the new task, while keeping the backbone model fixed. Thus, to implement the learned mask in ReRAM crossbar hardware, it is necessary in some embodiments to either develop complex control circuits to individually turn on/off each cell in convolution computation or reprogram the cell conductance to reflect the mask value—‘0’ (meaning this cell should not be involved in the new task computing path). It can be easily seen that both possible designs require significant hardware overhead in either much more complex extra peripheral circuits or re-programming partial ReRAM cell values. Also, since it is an element-wise mask, it requires a much larger memory overhead for the learned new mask. For example, for an 8-bit DNN model, the learned new element-wise mask in Piggyback will cause a memory overhead of ⅛ of the total model size only for one new task. Examples of different retraining strategies, including retraining with regularization, network extension, hard masking, and the disclosed soft masking, are shown in FIG. 2.

These limitations make it worthwhile to explore a new ReRAM crossbar friendly mask-based learning method that could leverage the mask based learning algorithm's benefit to avoid catastrophic forgetting in multi-task learning, and also could be easily implemented on existing crossbar based DNN accelerator hardware with minimal peripheral circuits and mask memory overhead, and more importantly, no need to re-program ReRAM cell values.

This disclosure is the first to propose a new crossbar friendly multi-task learning method, called XBM (Crossbar Binary Mask), which learns a crossbar column-wise binary mask for multi-task adaptation, while keeping the backbone model fixed. Note that, in popular crossbar-based DNN accelerator weight mapping, each column corresponds to a group of kernels, e.g., a group of 8×3×3 kernels could be mapped to one column of one 72×72 crossbar array to implement a parallel convolution computation. Therefore, in the disclosed XBM method, each column-wise binary mask value (1/0) controls the on/off of the entire column, rather than each cell element in Piggy-back. The above discussed objective could therefore be achieved with minimal hardware peripheral circuit modification and no need to re-program any ReRAM cell value to implement the masking operation. The disclosed method is distinguished from prior works in the following aspects:

Hardware friendly crossbar column-wise mask—To reduce the peripheral circuit overhead for implementing the masking function in hardware and avoid power hungry re-programming of ReRAM cells in multi-task adaptation, the present disclosure is the first to include a crossbar column-wise binary mask (XBM) based multi-task learning method, where each learned mask value (1/0) controls the on/off of an entire crossbar column for the new task inference, instead of each element as disclosed in prior works.

Mask size reduction—Another benefit of the disclosed XBM is a significant reduction in mask size (and thus, memory overhead) depending on the crossbar size. For instance, assuming a 72×72 crossbar size, only a single mask value is needed in the disclosed XBM to control one column, i.e., a group of 8×3×3 kernels, instead of 72 separate mask values, with 72 times smaller mask size than prior element-wise masks.

Gumbel-Sigmoid trick—Unlike the conventional hard thresholding method (A. Mallya et al., Proceedings of the European Conference on Computer Vision (ECCV), 2018, pp. 67-82) to learn the binary mask, the disclosed XBM learning method leverages the Gumbel-Sigmoid trick to better estimate the gradient of the mask during back-propagation.

### In-Memory Computing and Neural Network (NN) Accelerator

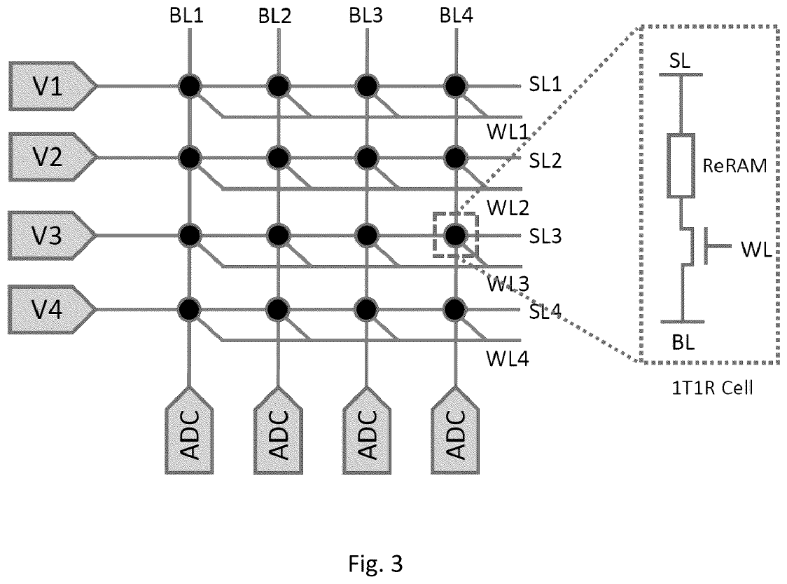

FIG. 3 shows the basic structure of a 1T1R crossbar array which can efficiently perform a vector-matrix multiplication (VMM) operation. In the depicted 1T1R array, the weight matrix is stored at the cross-point ReRAM cells as the conductance Gᵣᵣ(Gᵣᵣ=1/ReRam Resistance) while the input vector is fed through the horizontal source line (SL) as analog voltage Vᵢₙ (M. Hu et al., 2016 53nd ACM/EDAC/IEEE Design Automation Conference (DAC), 2016, pp. 1-6; F. Zhang et al., Proceedings of the 39th International Conference on Computer-Aided Design, ser. ICCAD '20. New York, NY, USA: Association for Computing Machinery, 2020). According to the Kirchhoff's Current Law (KCL), I_{BL}=Gᵣᵣ·Vᵢₙ, the current on the bit-line is the VMM result. An m×n sized crossbar array can perform a VMM operation between an m×1 vector and an m×n matrix in one step which reduces the time complexity from O(mn) to O (1).

A 2D convolution can be transformed to VMM either via a Toeplitz matrix or unrolling the convolution kernel. Recently many ReRAM crossbar array based neural network accelerator designs have been proposed to leverage the IMC's energy efficiency and high throughput (S. Mittal, Machine Learning and Knowledge Extraction, vol. 1, no. 1, pp. 75-114, 2019; L. Song et al., 2017 IEEE International Symposium on High Performance Computer Architecture (HPCA), 2017, pp. 541-552; X. Sun et al., 2018 Design, Automation Test in Europe Conference Exhibition, 2018, pp. 1423-1428; C. Eckert et al., Proceedings of the 45th Annual International Symposium on Computer Architecture, ser. ISCA '18. IEEE Press, 2018, p. 383-396).

Existing ReRAM crossbar designs focus on improving energy efficiency for fixed off-line trained models. Reprogramming is necessary if the dataset or task changes. Although Fouda et al. (M. E. Fouda et al., IEEE Transactions on Nanotechnology, vol. 18, pp. 704-716, 2019) proposed a mask-based method for crossbar arrays, this mask is used only during off-line training. Moreover, that method is employed to alleviate the sneak path problem, not for multi-task adaptation.

### Multi-Task Adaptation

Multi-task adaptation (S.-A. Rebuffi et al., Advances in Neural Information Processing Systems, 2017, pp. 506-516; A. Rosenfeld et al., IEEE transactions on pattern analysis and machine intelligence, 2018) aims to build a model which can adapt a task into multiple visual tasks/domains without forgetting previous knowledge, and meanwhile using as few parameters as possible. Rosenfeld et al. (A. Rosenfeld et al., IEEE transactions on pattern analysis and machine intelligence, 2018.) proposes to recombine the weights of the backbone model via controller modules in a channel-wise structure. Liu et al. (S. Liu et al., Proceedings of the IEEE Conference on Computer Vision and Pattern Recognition, 2019, pp. 1871-1880) proposes domain-specific attention modules for the backbone model. One related method is Piggyback (A. Mallya et al., Proceedings of the European Conference on Computer Vision (ECCV), 2018, pp. 67-82), which solves the issue by learning task-specific binary masks for each task. They achieve this by generating real-value masks which own the same size with weights, passing through a binarization function to obtain binary masks, which are then applied to existing, corresponding weights at the same position. The real-value mask and binary masks are denoted herein as m^{r} and m^{b} respectively. Then, the binarization function is given by:

$${m}^{b} = \{ \begin{matrix}1 , if {m}^{r} \geq τ \\ 0 , Otherwise\end{matrix} \qquad Equation 1$$

$$∇ {m}^{b} = ∇ {m}^{r} \qquad Equation 2$$

where τ is a constant threshold value. However, the gradient of binarization is non-differential during back-propagation. They use the straight-through estimator (STE) (I. Hubara et al., Advances in neural information processing systems, 2016, pp. 4107-4115) to solve this problem, which estimates the gradient of the real-value mask by the gradient of the binary mask. Furthermore, (L. Yang et al., Proceedings of the IEEE/CVF Conference on Computer Vision and Pattern Recognition, 2021, pp. 13 845-13 853; M. Mancini et al., Proceedings of the European Conference on Computer Vision (ECCV) Workshops, 2018, pp. 0-0) combine the binary mask with additional floating-point scaling values to improve the adaptation capacity, but these suffer from even higher computation and memory cost during the training procedure.

In some embodiments, a device as contemplated herein may comprise an array of ReRAM cells as discussed above, and may further comprise one or more mask buffers configured to store one or more binary masks for use in the calculation methods disclosed herein. A device may further include a controller, configured to read learned binary masks from the device and store them in the mask buffer, and/or also to select a binary mask from one or more stored binary masks in the mask buffer to deploy to the device, and/or fetch the input data and feed to the ReRAM cells for computation. In some embodiments, the controller may comprise a computing device to which the ReRAM is communicatively connected. In some embodiments, the controller may comprise a small embedded computing device or processor positioned on the same ReRAM module as the remainder of the device.

In some embodiments, a device as contemplated herein may comprise a column driver to control the ReRAM array based on the binary mask. In some embodiments, the device may comprise a column driver placed between the mask buffer and the ReRAM array.

### Methodology

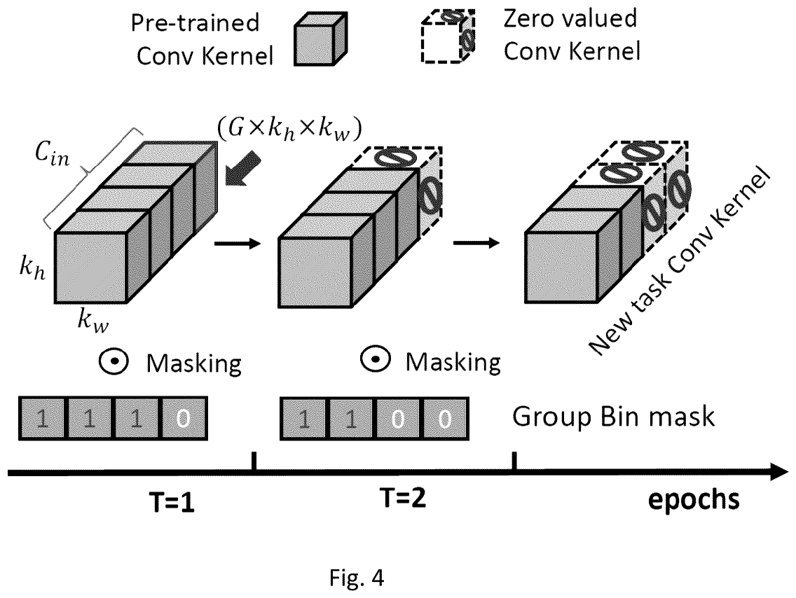

One aspect of the present disclosure relates to a crossbar-based column-wise binary mask learning method for fast and efficient multiple task adaptation, sometimes referred to herein as XBM. Following the multiple task adaptation setting in (L. Yang et al., Proceedings of the IEEE/CVF Conference on Computer Vision and Pattern Recognition, 2021, pp. 13 845-13 853; S.-A. Rebuffi et al., Advances in Neural Information Processing Systems, 2017, pp. 506-516), new tasks ({T₁, T₂, . . . T_{N}}) arrive sequentially and past tasks cannot be used for training future tasks. Based on this, the disclosed method aims to learn a task-specific mask for each arriving task without changing the parameters of the backbone model. Specifically, given a convolution layer, a set of weights w^{(l)} ∈ [symbol] ^{c}^{ᵢₙ}^{×c}^{ₒᵤₜ}^{×kh×kw} is denoted, where cᵢₙ, Cₒᵤₜ, kh, kw refer to the weight dimensions of [symbol] -th layer, including input channel (cᵢₙ), output channel (cₒᵤₜ), kernel height (kh) and kernel width (kw). The dataset D of the t-th task (Tₜ) is denoted as Dₜ={xₜ, yₜ}, where xₜ and yₜ are vectorized input data and label pair. To adapt the pre-trained backbone model with the parameter {w₁} from the initial task T₁ to a new task Tₜ with crossbar deployment efficiency, the model learns a task-specific mask in column-wise [symbol] ∈ [symbol] ^{G×kh×kw} that is applied to the fixed parameter w₁. By doing so, each mask element is shared by a column-wise G×kh×kw kernel, where G is the group ∈ {1, cᵢₙ} as shown in FIG. 4. Based on this idea, to learn the task Tₜ by masking the fixed parameter w₁, the objective can be mathematically formalized as:

$${min}_{{m}_{t}} ℒ ( f ( {x}_{t} ; \{ {m}_{t} \times {w}_{1} \} ) , {y}_{t} ) \qquad Equation 3$$

Where [symbol] 0 is the cross entropy loss function for image classification, and where f( ) is the neural network.

### Column-Wise Mask

According to the 1T1R crossbar's structure, the transistor's gates are connected by the source line (SL) either horizontally or vertically. Individually controlling each transistor to apply a binary element-wise mask is difficult. However, due to row/column wise parallelism, controlling the SL to turn on/off the entire row/column is an easy task for existing crossbar designs. In the conventional convolution kernel mapping method, the kernel is divided by output feature map dimension. For example, a cₒᵤₜ×cᵢₙ×kh×hw kernel will be reshaped to a (cᵢₙ×kh×kw, cₒᵤₜ) sized 2D matrix. With the development of deep learning in recent layers, deep neural networks grow into more complex and larger structures, the size of one filter cₘ×kh×kw is usually too large to fit into a single crossbar column. A general solution is to further partition and then map one filter into multiple columns.

Therefore, the mask size is defined as G×kh×kw to make it consistent with the size of a crossbar column, namely column-wise mask, where the group G ∈ {1, Cᵢₙ}. By doing so, a single mask value can control the entire column of a crossbar array, which improves the computation efficiency significantly compared to an element-wise mask. In one exemplary design, the size of the crossbar column is set as 72×1. Equivalently, the group size of the kernel-wise mask is set as 8×3×3 with the group G=8 in the algorithm.

### Learning the Binary Mask

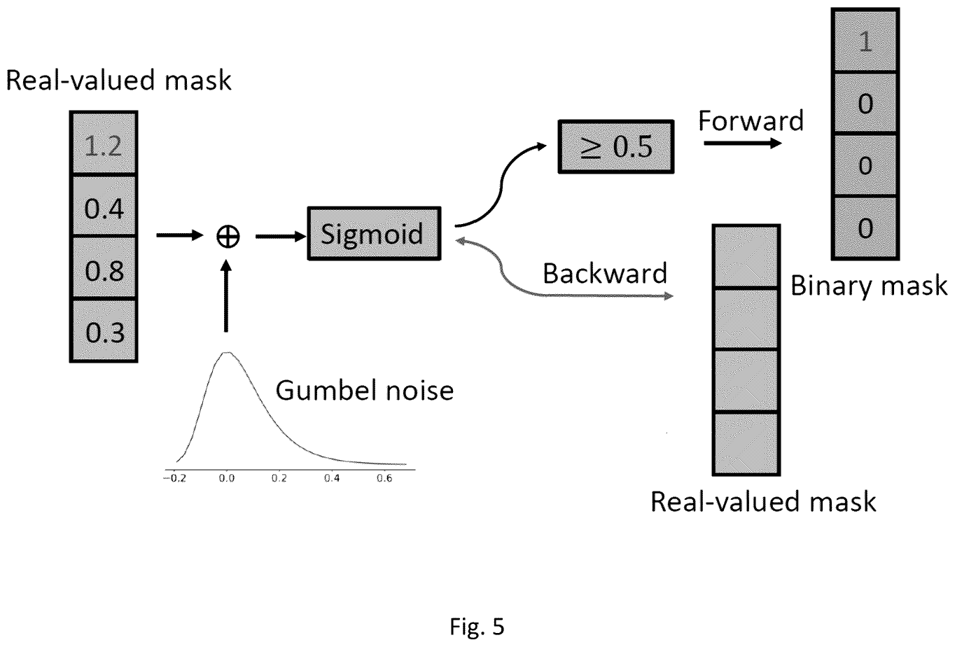

The conventional way (A. Mallya et al., Proceedings of the European Conference on Computer Vision (ECCV), 2018, pp. 67-82) of generating a binary trainable mask is to train a learnable real-valued mask (m^{r}) followed by a hard threshold function (i.e., sign function) to binarize it as shown in Equation 1. However, such a hard threshold function is not differential, and the general solution is to approximate the gradients by skipping the threshold function during back-propagation and update the real-value masks directly. The present disclosure includes a method to better estimate the gradient by using the Gumbel-Sigmoid trick as shown in FIG. 5.

First, the hard threshold function is relaxed to a continuous logistic function, for example the function shown in Equation 4 below:

$$σ ( {m}^{r} ) = \frac{1}{1 + exp ( - β {m}^{r} )}$$

where β is a constant scaling factor. Note that the logistic function of Equation 4 becomes closer to the hard thresholding function for higher β values. Then, to learn the binary mask, the Gumbel-Sigmoid trick is leveraged, inspired by Gumbel-Softmax (E. Jang et al., ICLR '17, 2017) that performs a differential sampling to approximate a categorical random variable. Because sigmoid can be viewed as a special two-class case of softmax, p(·) is defined using the Gumbel-Sigmoid trick as shown in Equation 5 below:

$$p ( {m}^{r} ) = \frac{exp ( ( log {π}_{0} + {g}_{0} ) / T )}{exp ( ( log {π}_{0} + {g}_{0} ) / T ) + exp ( {g}_{1} / T )} \qquad Equation 5$$

where π₀ represents σ(m^{r}). g₀ and g₁ are samples from the Gumbel distribution. The temperature T is a hyper-parameter to adjust the range of input values, where choosing a larger value could avoid gradient vanishing during back-propagation. Note that the output of p(m^{r}) becomes closer to a Bernoulli sample as T is closer to 0. Equation 5 can be further simplified as shown in Equation 6 as:

$$p ( {m}^{r} ) = \frac{1}{1 + exp ( - ( log {π}_{0} + {g}_{0} - {g}_{1} ) / T )} \qquad Equation 6$$

Benefiting from the differential property of Equation 4 and Equation 6, the real-value mask m^{r} can be embedded with existing gradient based back-propagation training. To represent p(m^{r}) as binary format m^{b}, a hard threshold (e.g., 0.5) is used during forward-propagation of training. Because most values in the distribution of p(m^{r}) move towards either 0 or 1 during training, generating the binary mask by p(m^{r}) (instead of the real-value mask m^{r} directly as mentioned in Equation 1) could have a more accurate decision, resulting in better accuracy.

### Hardware Structure and Weight Mapping

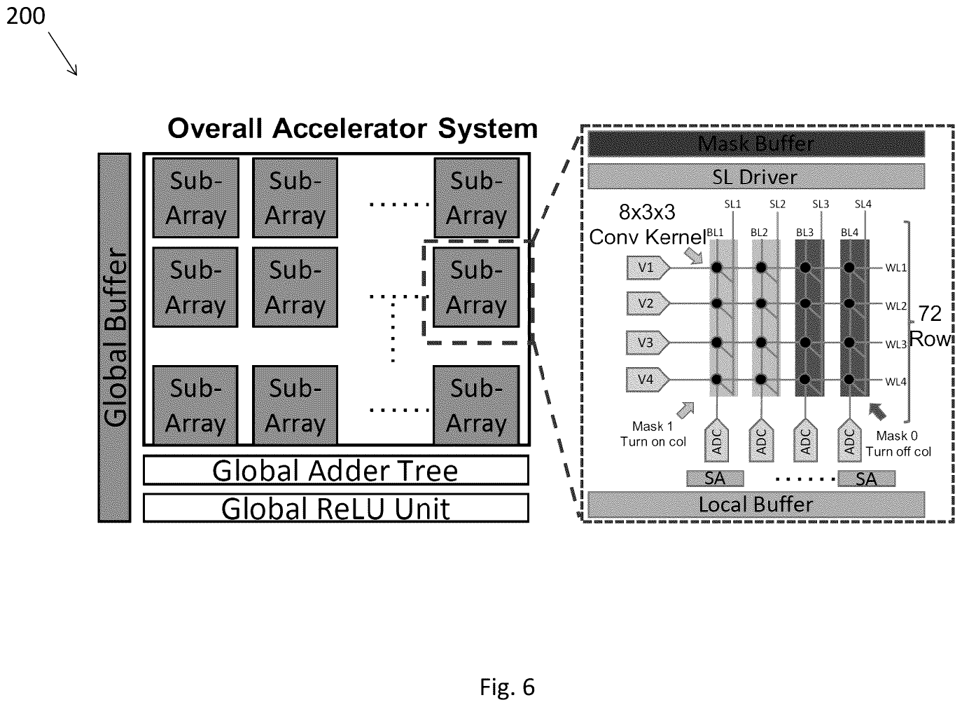

FIG. 6 shows an exemplary ReRAM crossbar-based NN accelerator device 200 to support the proposed column-wise binary mask. In some embodiments. the unrolled backbone model's convolutional kernel is mapped to the ReRAM crossbar sub-array. To be consistent with the aforementioned group size, a 72×72 crossbar array is used. Each crossbar array in the depicted embodiment can map a 72×8×3×3 convolution kernel. Any convolution kernel larger than 72×8×3×3 may in some embodiments be partitioned into multiple arrays. In that case, each array generates a partial sum instead of the activation. In some embodiments, a global adder tree may then be used to combine the partial sums and carry out the corresponding activation. The result is then sent to the global ReLU unit. In the crossbar array, each ReRAM cell stores 2 bits. In some embodiments, two adjacent columns are used to represent a 4-bit weight. In some embodiments, a shift-adder (SA) combines the two 2-bit results on bit lines (BLs) to generate a 4-bit partial sum activation.

For the fine-tuning or Piggyback methods, the re-programming method is used to update the fine-tuned weight or masked weight. During the inference, the SL driver turns on the whole array's 1T1R cells to perform the 72×8×3×3 convolution simultaneously.

In order to support the column-wise binary mask, a mask buffer is added to store the binary mask next to the corresponding crossbar array, as highlighted in FIG. 6 associated with each SL driver. To easily control the column on/off based on the mask value, the SL is connected vertically instead of horizontally. The SL connects with the gates of each cell transistor in the corresponding column. In this way, the column-wise binary mask value may be sent to the SL driver's input to turn on or off the entire column, with no modification to other existing peripheral circuits. For one 72×72 crossbar array, the memory buffer overhead is 72 bits. For example, for the whole ResNet-50 model, with 8×3×3 group size, the total memory overhead would be 23M/(8*3*3)/8 ≈40 KB. When compared with the 4-bit weight ResNet-50 model with 23M/2=11.5 MB, a 40 KB mask buffer is only 0.35% overhead.

In some embodiments disclosed herein, the mask buffer may be configured to store a single binary mask, while in other embodiments a mask buffer may be sized to store 2, 3, 4, 5, 6, 7, 8, 9, 10, or more binary masks, in such a way that switching between multiple different binary masks for different tasks may be accomplished.

Referring now to FIG. 6, in one aspect, the present invention relates to a network accelerator architecture device 200 for multiple task adaption comprising a volatile memory comprising a plurality of subarrays, each subarray comprising M rows and N columns of volatile memory cells. In some embodiments, device 200 comprises a source line driver connected to a plurality of N source lines, each source line corresponding to a column in the subarray. In some embodiments, device 200 comprises a binary mask buffer memory having size at least N bits, each bit corresponding to a column in the subarray, where a 0 corresponds to turning off the column for a convolution operation and a 1 corresponds to turning on the column for the convolution operation.

In some embodiments, device 200 comprises a controller configured to selectively drive each of the N source lines with a corresponding value from mask buffer, wherein each column in the subarray is configured to store a convolution kernel. In some embodiments, the volatile memory of device 200 is random access memory. In some embodiments, the volatile memory of device 200 is resistive random access memory.

In some embodiments, device 200 further comprises a real-valued mask buffer configured to store a calculated real-valued mask and a sigmoid element configured to convert the real-valued mask into a binary mask for storage in the binary mask buffer memory. In some embodiments, the real-valued mask buffer comprises floating-point values and the sigmoid element is a thresholding element having a threshold of 0.5. In some embodiments, each volatile memory cell stores 2 bits.

In some embodiments, device 200 further comprises a plurality of N/2 shift-adders, each configured to combine two 2-bit weights from adjacent columns of the subarray into a 4-bit partial sum activation. In some embodiments, the binary mask buffer memory has a size of at least 2N bits, and is configured to store two separate masks of size N, each bit of each mask corresponding to a column in the subarray.

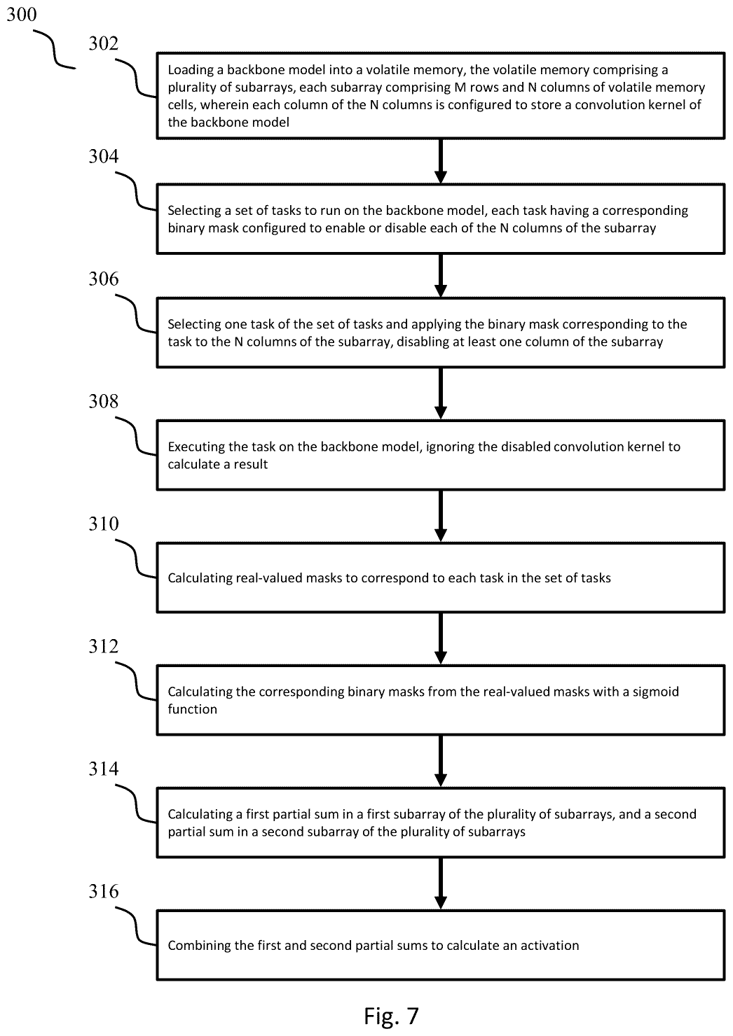

Referring now to FIG. 7, in one aspect, the present invention relates to a method 300 of machine learning for multiple task adaptation. In some embodiments, method 300 comprises the steps of loading a backbone model into a volatile memory, the volatile memory comprising a plurality of subarrays, each subarray comprising M rows and N columns of volatile memory cells, wherein each column of the N columns is configured to store a convolution kernel of the backbone model in step 302, selecting a set of tasks to run on the backbone model, each task having a corresponding binary mask configured to enable or disable each of the N columns of the subarray in step 304, selecting one task of the set of tasks and applying the binary mask corresponding to the task to the N columns of the subarray, disabling at least one column of the subarray in step 306, and executing the task on the backbone model, ignoring the disabled convolution kernel to calculate a result in step 308.

In some embodiments, method 300 further comprises the steps of calculating real-valued masks to correspond to each task in the set of tasks in step 310, and calculating the corresponding binary masks from the real-valued masks with a sigmoid function in step 312. In some embodiments, the volatile memory is a random-access memory. In some embodiments, the random-access memory is a resistive random-access memory.

In some embodiments, method 300 further comprises the steps of calculating a first partial sum in a first subarray of the plurality of subarrays, and a second partial sum in a second subarray of the plurality of subarrays in step 314, and combining the first and second partial sums to calculate an activation in step 316.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the system and method of the present invention. The following working examples therefore, specifically point out the exemplary embodiments of the present invention, and are not to be construed as limiting in any way the remainder of the disclosure.

### XBM Experiment

In this section the proposed XBM is evaluated from two aspects: algorithm and hardware. Similar to prior works, five image classification datasets are used: CUBS (C. Wah et al., California Institute of Technology, Tech. Rep. CNS-TR-2011-001, 2011), Stanford Cars (J. Krause et al., 2013 IEEE International Conference on Computer Vision Workshops, 2013, pp. 554-561), Flowers (M.-E. Nilsback et al., 2008 Sixth Indian Conference on Computer Vision, Graphics Image Processing, 2008, pp. 722-729), Wikiart (B. Saleh et al., CoRR, vol. abs/1505.00855, 2015), and Sketch (M. Eitz et al., ACM Trans. Graph. (Proc. SIGGRAPH), vol. 31, no. 4, pp. 44:1-44:10, 2012). ResNet-50 was used as the backbone model which was pre-trained on the ImageNet dataset [O. Russakovsky et al., 2015].

### Algorithm Evaluation

Table 1 below shows the inference accuracy on different datasets. ResNet-50 was used as the backbone model which was trained on the ImageNet dataset with 4-bit weight and 4-bit activation quantization. The quantization method was adopted from PROFIT (E. Park et al., 2020). The group size G=8 was chosen in the experiment. Fine-tuning the backbone model achieved the best accuracy in most datasets, since fine-tuning has the highest flexibility to change any weight to any quantized level. Although Piggyback was able to adapt any weight, the binary mask made it lose some representation ability. Thus Piggyback showed slightly worse accuracy than fine-tuning. The proposed XBM not only has the same binary limitation but also has the group concept. One would expect those limitations to further contaminate the accuracy. However, owing to the softmax trick that can better estimate the gradient, there was not much accuracy drop compared to the element-wise Piggyback, even though one mask value was shared among 72 weights. Due to the group mask sharing, XBM's mask size was only 1/72 of Piggyback. For the ResNet-50 backbone model, Piggyback's element-wise binary mask required 23 M/8=2.88 MB, while the XBM only consumed around 40 KB.

TABLE 1
MULTI-TASK ADAPTATION ACCURACY

| | | Continual Learning (4-bit Quantization) | |
|---|---|---|---|
| | Finetune | Piggyback | XBM (This work) |
| CUBS | 73.02% | 74.47% | 75.53% |
| Stanford_cars | 85.92% | 86.85% | 85.96% |
| Flowers | 95.34% | 91.09% | 90.81% |
| Wikiart | 74.96% | 68.97% | 67.60% |
| Sketches | 80.92% | 78.88% | 76.95% |

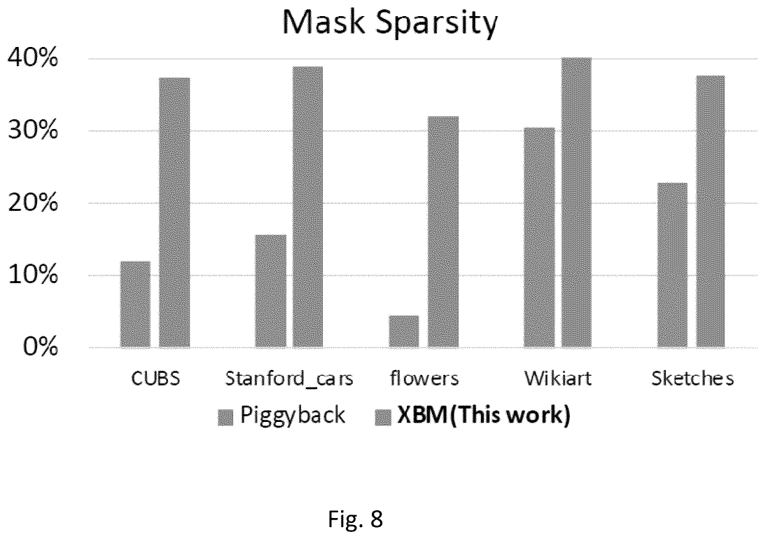

FIG. 8 shows the mask sparsity among Piggyback and the disclosed XBM. Because the sparsity values for Finetune are too low, they are not plotted in this figure. The proposed method always achieves more than 30% mask sparsity. Due to the group mask, it can be easily applied on a crossbar array. Such high sparsity leads to more than 30% energy reduction, which is explained in the next sub-section.

### Hardware Evaluation

For a fair comparison, all multi-task adaptation methods were implemented on the same evaluation hardware platform as shown in FIG. 6.

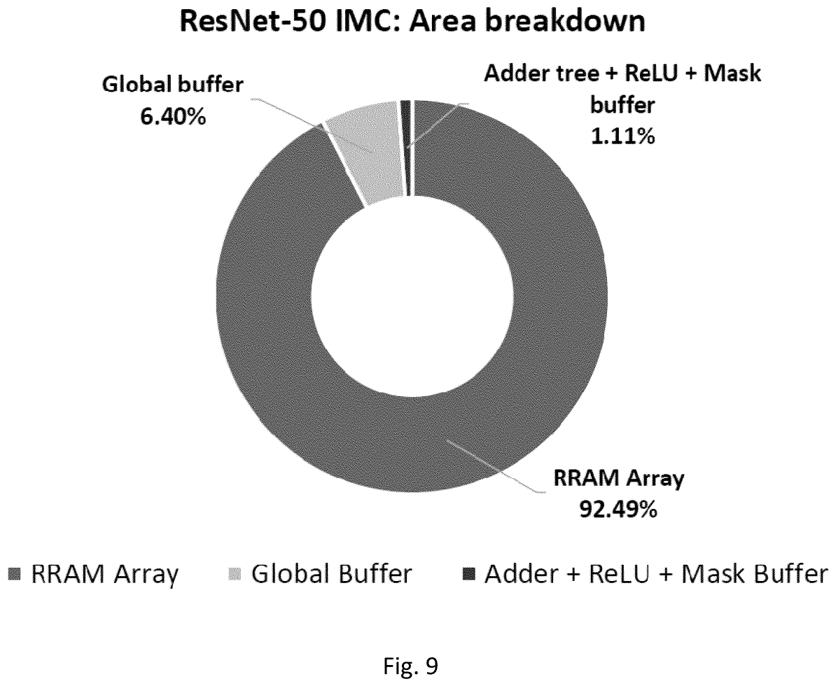

The circuit level simulator NeuroSim (X. Peng et al., IEEE International Electron Devices Meeting (IEDM), 2019, pp. 32.5.1-32.5.4) was used to evaluate the hardware performance of different learning schemes. The 4-bit quantized targeted DNNs were implemented based on 2-bit per cell HfO₂ 1T1R ReRAM devices, characterized from (W. Wu et al., IEEE Symposium on VLSI Technology, 2018, pp. 103-104) and projected to 32 nm CMOS nodes. Table 2 and FIG. 9 summarize the detailed ReRAM array characteristics and total area consumption. Each ReRAM column is connected to a 5-bit successive approximation register (SAR) analog-to-digital converter (ADC). To avoid frequent off-chip memory access, we choose the global buffer as the same size of the largest feature map during the inference process.

TABLE 2
HARDWARE SPECIFICATIONS
RRAM Sub-Array

| Components | Area (μm2) | Energy (pJ) |
|---|---|---|
| Memory Array (72 × 72) | 84.93 | |
| Switch Matrix (WL and SL) | 457.3 | 1.1 |
| SAR ADC (5-bit) | 8,409.30 | 8.3 |
| Shift-Add-Input | 1,412.90 | 6.8 |
| Shift-Add-Weight (2 col use 1) | 825.8 | 1 |
| Mask Buffer (72 × 1) | 190.4 | 0.003/bit/access |
| Total 11,380.2 17.2 | | |

Peripheral Circuits

| | | |
|---|---|---|
| 1 stage AdderTree (128 units) | 2,510.30 | 4.4 |
| 2 stage AdderTree (128 units) | 7,740.10 | 13.7 |
| 3 stage AdderTree (128 units) | 18,408.80 | 32.6 |
| Global Buffer (64 × 112 × 112 × 4) | 8,490,034 | 0.003/bit/access |
| ReLU (128 units) | 939.5 | 0.9 |

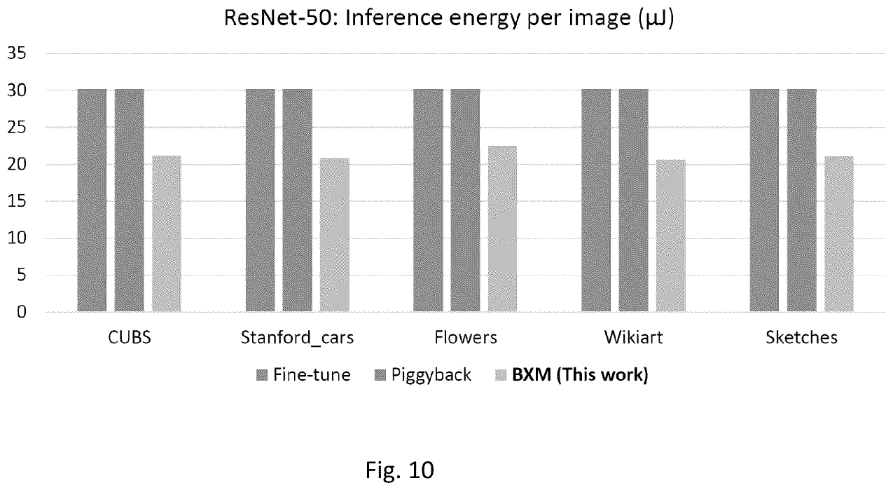

Table 3 below summarizes the total energy consumption per input image (224×224×3). The element-wise masks generated by Piggyback (A. Mallya et al., Proceedings of the European Conference on Computer Vision (ECCV), 2018, pp. 67-82) partially program the weights to zero, but were not able to effectively reduce the overall energy consumption since the rest of the cells along each column remained active. Therefore, the inference energy consumption was identical after fine-tuning or Piggyback (A. Mallya et al., Proceedings of the European Conference on Computer Vision (ECCV), 2018, pp. 67-82) learning. The proposed XBM algorithm exploits the mask sparsity in a column-wise fashion. As a result, one or more entire columns can be removed from the hardware inference process, and the overall energy consumption will be reduced. Compared to the normal fine-tuning and Piggyback (A. Mallya et al., Proceedings of the European Conference on Computer Vision (ECCV), 2018, pp. 67-82) learning schemes, the XBM can reduce energy consumption by ˜1.5× with negligible hardware overhead. The inference energies in Table 3 are shown graphically in FIG. 10

TABLE 3
INFERENCE ENERGY PER IMAGE

| | 4-bit ResNet-50 | | |
|---|---|---|---|
| Method/Dataset | Finetune | Piggyback | XBM (Binary Group Mask) |
| CUBS | 30.25 μJ | 30.25 μJ | 21.20 μJ |
| Stanford_cars | 30.25 μJ | 30.25 μJ | 20.82 μJ |
| flowers | 30.25 μJ | 30.25 μJ | 22.53 μJ |
| Wikiart | 30.25 μJ | 30.25 μJ | 20.63 μJ |
| Sketches | 30.25 μJ | 30.25 μJ | 21.12 μJ |

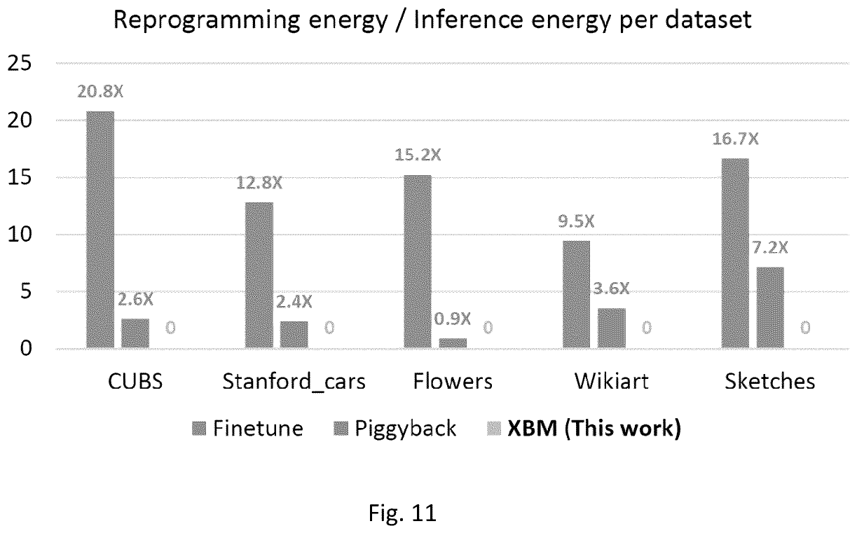

Fine-tuning the model entirely or learning the element-wise masks requires reprogramming or even second-time deployment, which consumes enormous amounts of energy. The energy consumption caused by the weight increase/decrease during the programming can be computed based on the writing voltage, writing pulses, and conductance level changes (W. Wu et al., IEEE Symposium on VLSI Technology, 2018, pp. 103-104; P.-Y. Chen et al., IEEE Transactions on Computer-Aided Design of Integrated Circuits and Systems, vol. 37, no. 12, pp. 3067-3080, 2018). FIG. 11 demonstrated the energy consumption overhead of the reprogramming. Compared to the inference energy consumption of the entire test set, reprogramming the entire model causes a massive amount of energy overhead (over 20×). Such significant energy overhead of the previous method promotes the disclosed method as the best solution. Learning the new features by turning off the ReRAM columns enabled the disclosed method to forego reprogramming and second-time deployment.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A neural network accelerator architecture for multiple task adaptation, comprising:
a volatile memory comprising a plurality of subarrays, each subarray comprising M rows and N columns of volatile memory cells;
a source line driver connected to a plurality of N source lines, each source line corresponding to a column in the subarray;
a binary mask buffer memory having size at least N bits, each bit corresponding to a column in the subarray, where a 0 corresponds to turning off the column for a convolution operation and a 1 corresponds to turning on the column for the convolution operation; and
a controller configured to selectively drive each of the N source lines with a corresponding value from the mask buffer;
wherein each column in the subarray is configured to store a convolution kernel.

2. The neural network accelerator of claim 1, wherein the volatile memory is a random access memory.

3. The neural network accelerator of claim 2, wherein the volatile memory is a resistive random access memory.

4. The neural network accelerator of claim 1, further comprising:
a real-valued mask buffer configured to store a calculated real-valued mask; and
a sigmoid element configured to convert the real-valued mask into a binary mask for storage in the binary mask buffer memory.

5. The neural network accelerator of claim 1, wherein the real-valued mask buffer comprises floating-point values and the sigmoid element is a thresholding element having a threshold of 0.5.

6. The neural network accelerator of claim 1, wherein each volatile memory cell stores 2 bits.

7. The neural network accelerator of claim 6, further comprising a plurality of N/2 shift-adders, each configured to combine two 2-bit weights from adjacent columns of the subarray into a 4-bit partial sum activation.

8. The neural network accelerator of claim 1, wherein the binary mask buffer memory has a size of at least 2N bits, and is configured to store two separate masks of size N, each bit of each mask corresponding to a column in the subarray.

10. A method of machine learning for multiple task adaptation, comprising:
loading a backbone model into a volatile memory, the volatile memory comprising a plurality of subarrays, each subarray comprising M rows and N columns of volatile memory cells, wherein each column of the N columns is configured to store a convolution kernel of the backbone model;
selecting a set of tasks to run on the backbone model, each task having a corresponding binary mask configured to enable or disable each of the N columns of the subarray;
selecting one task of the set of tasks and applying the binary mask corresponding to the task to the N columns of the subarray, disabling at least one column of the subarray; and
executing the task on the backbone model, ignoring the disabled convolution kernel to calculate a result.

11. The method of claim 10, further comprising the steps of calculating real-valued masks to correspond to each task in the set of tasks; and
calculating the corresponding binary masks from the real-valued masks with a sigmoid function.

12. The method of claim 10, wherein the volatile memory is a random-access memory.

13. The method of claim 12, wherein the random-access memory is a resistive random-access memory.

14. The method of claim 10, further comprising calculating a first partial sum in a first subarray of the plurality of subarrays, and a second partial sum in a second subarray of the plurality of subarrays; and
combining the first and second partial sums to calculate an activation.
